(19) United States
(12) Patent Application Publication
(10) Pub. No.: US 2026/0077217 A1
(43) Pub. Date: Mar. 19, 2026

(54) SUPPLIED AIR RESPIRATOR

(71) Applicant: Lincoln Global, Inc., Santa Fe Springs, CA (US)

(72) Inventors: Paul H. Rumpke, Rocky River, OH (US); Dhananjay B. Deshpande, Twinsburg, OH (US)

(21) Appl. No.: 18/889,547

(22) Filed: Sep. 19, 2024

(51) Int. Cl. A62B 7/02; A62B 7/12

(52) U.S. Cl. CPC A62B 7/02; A62B 7/12

(57) ABSTRACT

A body-worn supplied air respirator includes a belt bracket, and a regulator housing extending along a first axis. The regulator housing includes a breathing air flow regulator. A breathing air hose connector is located downstream of the breathing air flow regulator. A rotational connection is provided between the belt bracket and the regulator housing. The rotational connection permits rotation of the regulator housing relative to the belt bracket about a second axis substantially perpendicular to the first axis. The rotational connection allows the regulator housing to be rotated clockwise or counterclockwise to a plurality of predetermined rotational positions.

### BACKGROUND OF THE INVENTION

### Field of the Invention

The present invention relates to respirator devices, in particular to body-worn supplied air respirators (SAR) that can supply breathing air to a helmet.

### Description of Related Art

Respirator devices, such as powered air purifying respirators (PAPR) and supplied air respirators can be worn by a welder during welding operations to supply clean breathing air to a welding helmet. Both devices are typically worn on a belt and are located along a user's lower back. A difference between a PAPR and a SAR is that a PAPR draws in and filters ambient air near the user and supplies the filtered air to the helmet, whereas a SAR is supplied with pressurized air via an air hose, and a regulator within the SAR reduces the pressure and controls the flow of air to the helmet. One disadvantage of a SAR is that the user is tethered to a supply of pressurized air via the supply air hose. Further, the orientation of the SAR along a user's body is typically fixed and not adjustable, which can result in the breathing air hose between the helmet and the regulator becoming strained as the user changes positions or stance. The orientation of some SARs can be changed by the user from a vertical orientation to a horizontal orientation, but this requires the user removing the mounting belt from around his waist, removing the SAR mounting bracket from the belt, reinstalling the SAR mounting bracket on the belt in a desired orientation, and then reattaching the belt around his waist. Moreover, the user only has two selectable orientations for the SAR (i.e., vertical and horizontal). It would be desirable to provide a SAR in which its orientation along the user's body is more easily adjustable to a desired orientation.

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is a body-worn supplied air respirator comprising a belt bracket, and a regulator housing extending along a first axis. The regulator housing includes a breathing air flow regulator. A breathing air hose connector is located downstream of the breathing air flow regulator. A rotational connection is provided between the belt bracket and the regulator housing. The rotational connection permits rotation of the regulator housing relative to the belt bracket about a second axis substantially perpendicular to the first axis. The rotational connection allows the regulator housing to be rotated clockwise or counterclockwise to a plurality of predetermined rotational positions.

In accordance with another aspect of the present invention, provided is a body-worn supplied air respirator comprising a belt bracket having an internal ring gear, and a regulator housing extending along a first axis. The regulator housing includes a breathing air flow regulator. A breathing air hose connector is located downstream of the breathing air flow regulator. A rotational connection is provided between the belt bracket and the regulator housing. The rotational connection includes a spring tooth that engages the internal ring gear on the belt bracket to permit rotation of the regulator housing relative to the belt bracket about a second axis substantially perpendicular to the first axis. The rotational connection allows the regulator housing to be rotated clockwise or counterclockwise to a plurality of predetermined rotational positions defined by the internal ring gear.

In accordance with another aspect of the present invention, provided is a body-worn supplied air respirator comprising a belt bracket, and a regulator housing having a volumetric air flow regulator. A breathing air hose connector is located downstream of the volumetric air flow regulator and is connected to the regulator housing via a rotational connection that permits the breathing air hose connector to rotate about a first axis. A rotational connection is provided between the belt bracket and the regulator housing. The rotational connection permits rotation of the regulator housing relative to the belt bracket about a second axis substantially perpendicular to the first axis. The rotational connection allows the regulator housing to be rotated clockwise or counterclockwise.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 shows welder wearing a supplied air respirator;

FIG. 2 shows the supplied air respirator;

FIG. 3 shows the supplied air respirator;

FIG. 4 shows the supplied air respirator;

FIG. 5 shows the supplied air respirator;

FIG. 6 shows the supplied air respirator;

FIG. 7 shows a portion of the supplied air respirator;

FIG. 8 shows a portion of the supplied air respirator; and

FIG. 9 shows a portion of the supplied air respirator.

### DETAILED DESCRIPTION OF THE INVENTION

The present invention relates to respirator devices, in particular to body-worn supplied air respirators (SAR) that can supply breathing air to a helmet. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

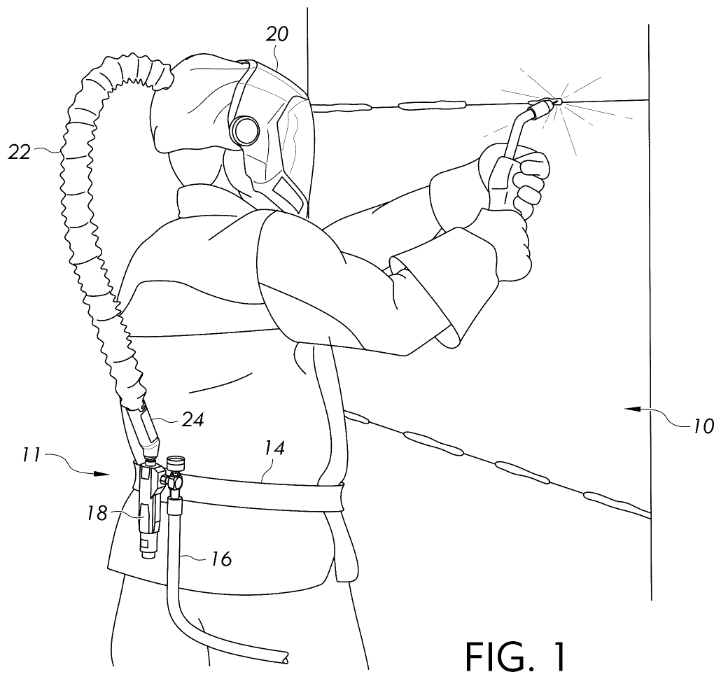

FIG. 1 shows a user 10 (e.g., a welder) having a body-worn SAR 11 while performing a welding operation. The SAR 11 is worn on a belt 14 around the user's waist and is typically located along the user's lower back. Pressurized air (e.g., 50-90 psi) is supplied to the SAR 11 through a supply air hose 16. The SAR 11 has a regulator housing 18 that includes a breathing air flow regulator (e.g., a volumetric air flow regulator). The SAR 11 supplies breathing air to a helmet, such as welding helmet 20 through, a breathing air hose 22. The SAR 11 includes a breathing air hose connector 24 that is located downstream of the breathing air flow regulator for connecting the breathing air hose 22 to the output of the breathing air flow regulator. The breathing air hose 22 extends from the breathing air hose connector 24 to the helmet 20. The breathing air hose connector 24 can be connected to the regulator housing 18 via a swivel or rotational connection that permits the breathing air hose connector to rotate (e.g., by 360° or more) relative to the regulator housing. The breathing air hose connector 24 can provide a noise reduction function to muffle sound or noise conducted to the helmet 20 during SAR 11 use. The SAR 11 can provide a cooling function to provide cool air to the welding helmet 20. The air flow and cooling provided by the SAR 11 to the helmet 20 can be adjusted by the user. An example volumetric flow range for the SAR 11 is 180-350 liters per minute (lpm). The construction and operation of SARs is well-known in the art and need not be discussed in detail herein.

The present invention concerns a rotational connection between a belt bracket for the SAR and the regulator housing. The rotational connection permits rotation of the regulator housing relative to the belt bracket. This allows the user to orient the regulator housing to a desired angle to adjust the direction of the breathing air hose output. The user can rotate or adjust the orientation of the regulator housing during use and without having to remove the SAR belt. The ability to rotate the regulator housing reduces the risk of the breathing air hose being stretched or strained. In certain embodiments, the rotational connection allows the regulator housing to rotate relative to the belt bracket on its own as the user changes positions or stances, without the user manually manipulating the regulator housing. In certain embodiments, the rotational connection provides a plurality of predetermined rotational positions for the regulator housing so that the regulator housing generally remains in a desired orientation during use unless sufficient torque is applied to the regulator housing to adjust its orientation.

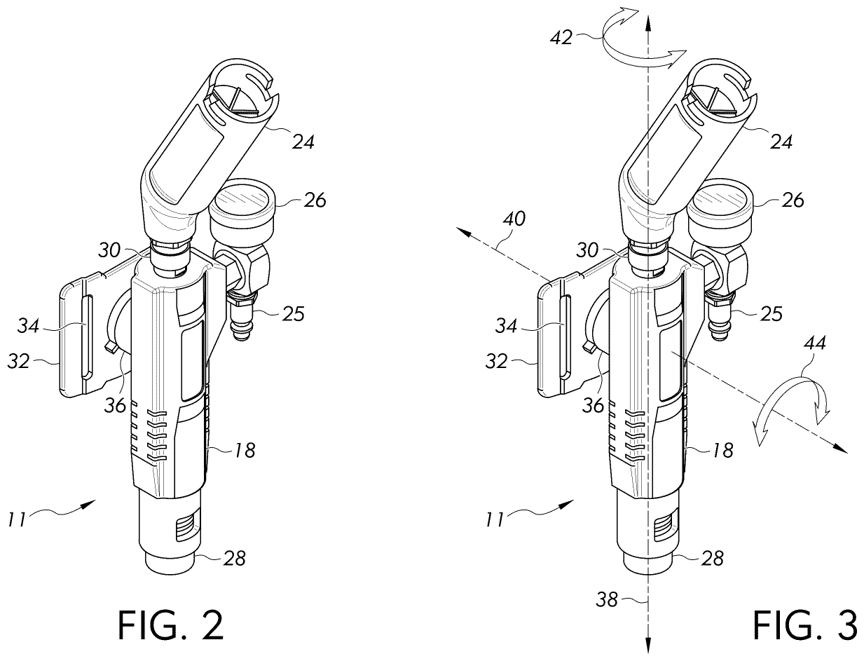

FIGS. 2-6 show the SAR 11 in further detail. The SAR 11 includes a connector 25 or compressed air inlet for the supply air hose. The connector 25 can be a male quick connect fitting that is typically used for pneumatic couplings. The SAR 11 can further include an inlet air pressure gauge 26 that displays the inlet pressure to the SAR. In certain embodiments, the inlet air pressure gauge 26 can include a scale with marked ranges that quickly inform the user whether the inlet air pressure is too low, optimal, or too high for a desired range of air flows to the helmet. An adjustment knob 28 on the regulator housing 18 allows the user to set the desired air flow and cooling provided to the helmet. As noted above, the breathing air hose connector 24 can be connected to the regulator housing 18 via a swivel or rotational connection 30 that permits the breathing air hose connector to rotate relative to the regulator housing.

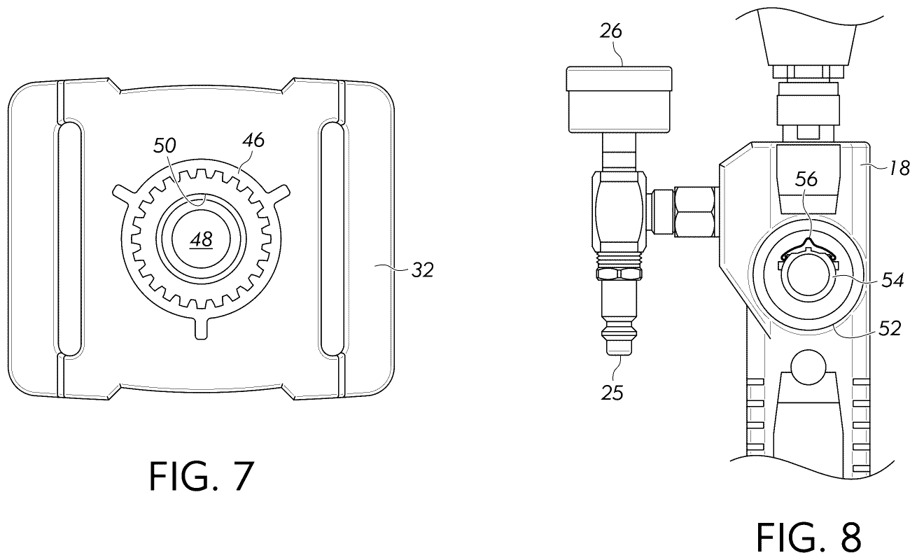

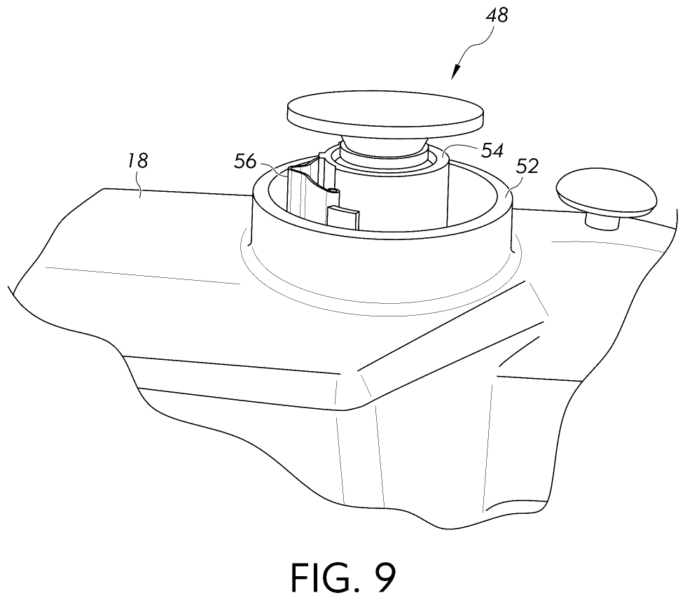

A belt bracket 32 for the SAR 11 allows the user to wear the SAR on a belt, and has appropriate openings 34 (e.g., two slots) through which the belt can be passed. The SAR 11 includes a rotational connection 36 between belt bracket 32 and the regulator housing 18 that allows the regulator housing to rotate clockwise or counterclockwise relative to the belt bracket. Details of the structure of an example embodiment of the rotational connection 36 are discussed below with respect to FIGS. 7-9.

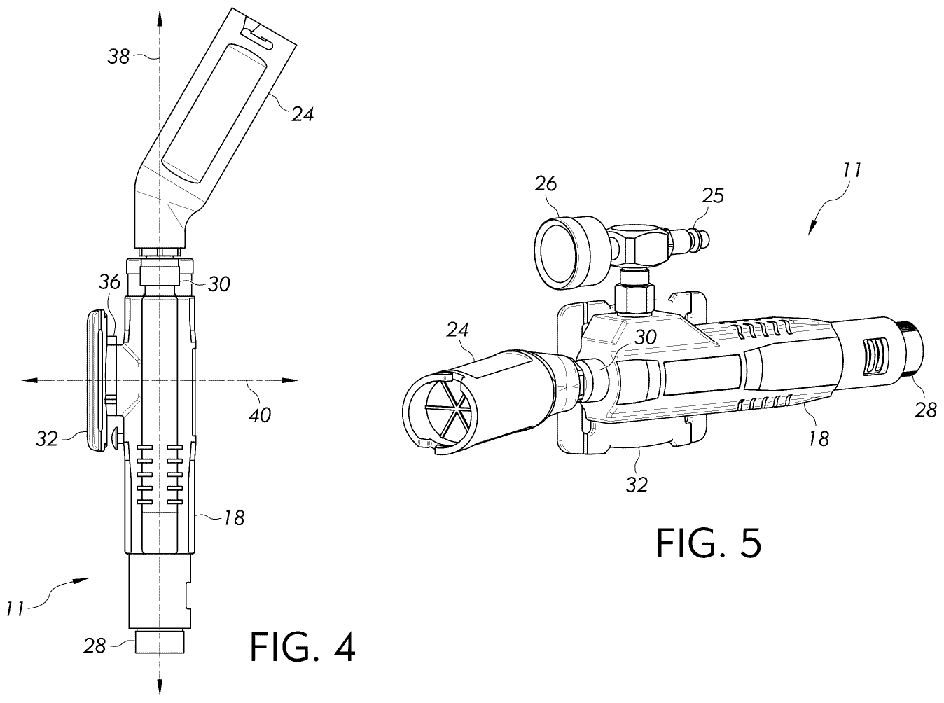

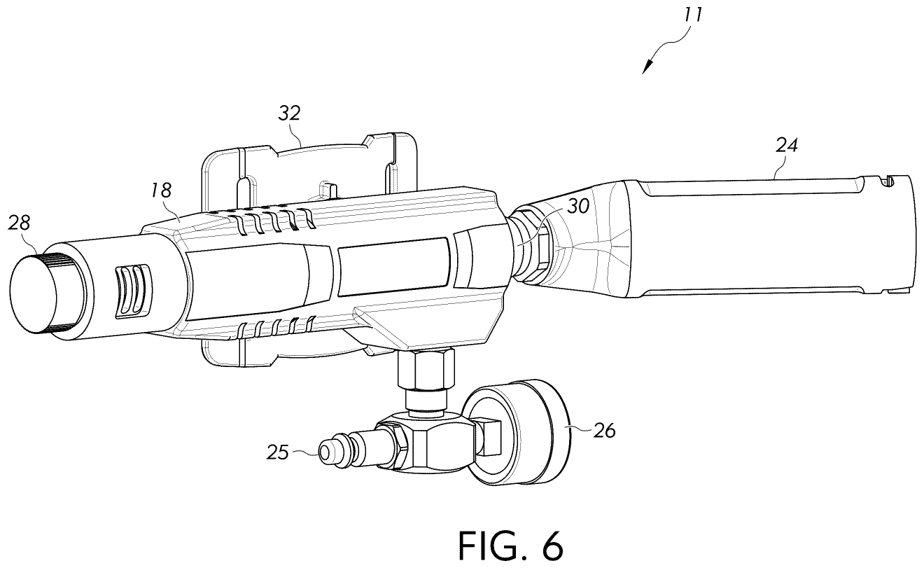

FIGS. 3 and 4 show the SAR 11 with axes 38, 40 added to illustrate how the regulator housing 18 and breathing air hose connector 24 can rotate. The regulator housing 18 extends along a first axis 38. The swivel or rotational connection 30 between the breathing air hose connector 24 and the regulator housing 18 allows the breathing air hose connector to rotate clockwise and counterclockwise about (i.e., around) the first axis 38. The rotation 42 of the breathing air hose connector 24 about the first axis 38 is schematically shown in FIG. 3. The rotational connection 36 between the belt bracket 32 and the regulator housing 18 allows the regulator housing to rotate clockwise and counterclockwise on the belt bracket about (i.e., around) a second axis 40. The rotation 44 of the regulator housing 18 about the second axis 40 is also shown schematically in FIG. 3. In the example embodiment shown in the figures, the first axis 38 and the second axis 40 are perpendicular or substantially perpendicular (e.g., within 3 degrees of perpendicular). However, it is to be appreciated that the first axis 38 and the second axis 40 need not be perpendicular or substantially perpendicular. FIG. 5 shows the regulator housing 18 rotated counterclockwise relative to the belt bracket 32 and FIG. 6 shows the regulator housing rotated clockwise relative to the belt bracket.

FIGS. 7-9 illustrate one example embodiment of a rotational connection between the belt bracket and the regulator housing. However, one of ordinary skill in the art will appreciate that various types of rotational connections could be used to attach the regulator housing to the belt bracket and allow rotation of the regulator housing relative to the belt bracket. FIG. 7 shows an internal ring gear 46 that forms part of the rotational connection. The internal ring gear 46 projects outward from the belt bracket 32 toward the regulator housing (not shown). In certain embodiments, the internal ring gear 46 is integrally formed with the belt bracket 32, whereas in other embodiments the internal ring gear is attached to the belt bracket by suitable fasteners, an adhesive, etc. The internal ring gear 46 has a plurality of inwardly projecting gear teeth, and the gaps between adjacent gear teeth provide predetermined rotational positions for the regulator housing. It can be seen that the belt bracket 32 has an opening 50 that is concentric with the internal ring gear 46. At the center of the internal ring gear 46 is a pin 48 having a shaft that extends through the opening 50 in the belt bracket 32. The pin 48 has a head that is located at the rear side of the belt bracket 32, and the head is wider than the opening 50 (i.e., the diameter of the head is wider than the diameter of the opening). The pin's 48 shaft acts as an axle upon which the regulator housing can rotate.

FIG. 8 shows the rear side of the regulator housing 18 that faces the belt bracket (not shown), and the portions of the rotational connection that are located on the regulator housing. These portions of the rotational connection include an outer cup 52 for receiving the internal ring gear 46 (FIG. 7) on the belt bracket, a central hub 54, and a spring tooth 56. In an example embodiment, the spring tooth 56 and pin 48 (FIG. 7) are made from metallic materials whereas other portions of the rotational connection are made from polymer or plastic materials. The cup 52 and/or the central hub 54 can be integrally formed with the regulator housing 18 or attached thereto by suitable fasteners, adhesives, etc. In certain embodiments, the spring tooth 56 can be integrally formed with the central hub 54. In the example embodiment shown in FIG. 8, the central hub 54 includes positioning elements (e.g., protrusions and/or recesses) for properly locating the spring tooth along the central hub.

With reference to FIGS. 7-9, when the two halves of the rotational connection, located respectively on the belt bracket 32 and regulator housing 18, are joined together, the shaft of the pin 48 supports the central hub 54 like an axle, so that the regulator housing can rotate on the shaft of the pin. The internal ring gear 46 is received in and surrounded by the cup 52, and the spring tooth 56 engages the internal ring gear (in particular, a gap between adjacent gear teeth of the internal ring gear). The spring tooth 56 extends from the central hub 54 toward the internal ring gear 46 to engage the internal ring gear.

The rotational connection allows the regulator housing 18 to be rotated clockwise or counterclockwise to a plurality of predetermined rotational positions defined by the internal ring gear 46. In particular, the gaps between adjacent gear teeth on the internal ring gear 46 provide the plurality of predetermined rotational positions for the regulator housing 18. The spring tooth 56 is resilient and can slide into and out of the gaps between the adjacent gear teeth on the internal ring gear 46 as the regulator housing 18 is rotated, but it will also hold the regulator housing in a desired orientation relative to the belt bracket 32 unless sufficient torque is applied. The number of predetermined rotational positions for the regulator housing depends on the number of gear teeth on the internal ring gear 46. In an example embodiment, the internal ring gear 46 includes at least 20 gear teeth (e.g., 24 gear teeth or 15° between each predetermined rotational position). It is to be appreciated that the rotational connection between the regulator housing 18 and the belt bracket 32 discussed herein permits greater than 360° of rotation of the regulator housing relative to the belt bracket in both the clockwise and counterclockwise directions.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A body-worn supplied air respirator, comprising:
a belt bracket;
a regulator housing extending along a first axis, wherein the regulator housing includes a breathing air flow regulator;
a breathing air hose connector located downstream of the breathing air flow regulator; and
a rotational connection between the belt bracket and the regulator housing, wherein the rotational connection permits rotation of the regulator housing relative to the belt bracket about a second axis substantially perpendicular to the first axis, and
wherein the rotational connection allows the regulator housing to be rotated clockwise or counterclockwise to a plurality of predetermined rotational positions.

2. The body-worn supplied air respirator of claim 1, wherein the rotational connection permits greater than 360 degrees of rotation of the regulator housing relative to the belt bracket.

3. The body-worn supplied air respirator of claim 1, wherein the belt bracket includes an internal ring gear that defines the plurality of predetermined rotational positions.

4. The body-worn supplied air respirator of claim 3, wherein the rotational connection includes a spring tooth that extends from a central hub of the rotational connection and engages a gap between respective gear teeth of the internal ring gear.

5. The body-worn supplied air respirator of claim 1, further comprising a compressed air inlet, and a breathing air hose extending from the breathing air hose connector to a helmet.

6. The body-worn supplied air respirator of claim 5, further comprising an inlet air pressure gauge.

7. The body-worn supplied air respirator of claim 1, wherein the breathing air hose connector is rotatable about the first axis.

8. A body-worn supplied air respirator, comprising:
a belt bracket having an internal ring gear;
a regulator housing extending along a first axis, wherein the regulator housing includes a breathing air flow regulator;
a breathing air hose connector located downstream of the breathing air flow regulator; and
a rotational connection between the belt bracket and the regulator housing, wherein the rotational connection includes a spring tooth that engages the internal ring gear on the belt bracket to permit rotation of the regulator housing relative to the belt bracket about a second axis substantially perpendicular to the first axis, and
wherein the rotational connection allows the regulator housing to be rotated clockwise or counterclockwise to a plurality of predetermined rotational positions defined by the internal ring gear.

9. The body-worn supplied air respirator of claim 8, wherein the rotational connection permits greater than 360 degrees of rotation of the regulator housing relative to the belt bracket.

10. The body-worn supplied air respirator of claim 8, further comprising a compressed air inlet, and a breathing air hose extending from the breathing air hose connector to a helmet.

11. The body-worn supplied air respirator of claim 10, further comprising an inlet air pressure gauge.

12. The body-worn supplied air respirator of claim 8, wherein the breathing air hose connector is rotatable about the first axis.

13. The body-worn supplied air respirator of claim 8, wherein the internal ring gear includes at least 20 gear teeth.

14. A body-worn supplied air respirator, comprising:
a belt bracket;
a regulator housing having a volumetric air flow regulator;
a breathing air hose connector located downstream of the volumetric air flow regulator and connected to the regulator housing via a rotational connection that permits the breathing air hose connector to rotate about a first axis; and
a rotational connection between the belt bracket and the regulator housing, wherein the rotational connection permits rotation of the regulator housing relative to the belt bracket about a second axis substantially perpendicular to the first axis, and
wherein the rotational connection allows the regulator housing to be rotated clockwise or counterclockwise.

15. The body-worn supplied air respirator of claim 14, wherein the rotational connection allows the regulator housing to be rotated to a plurality of predetermined rotational positions.

16. The body-worn supplied air respirator of claim 14, wherein the rotational connection permits greater than 360 degrees of rotation of the regulator housing relative to the belt bracket.

17. The body-worn supplied air respirator of claim 14, wherein the belt bracket includes an internal ring gear that defines the plurality of predetermined rotational positions.

18. The body-worn supplied air respirator of claim 17, wherein the rotational connection includes a spring tooth that extends from a central hub of the rotational connection and engages a gap between respective gear teeth of the internal ring gear.

19. The body-worn supplied air respirator of claim 17, wherein the internal ring gear includes at least 20 gear teeth.

20. The body-worn supplied air respirator of claim 14, further comprising a compressed air inlet, and a breathing air hose extending from the breathing air hose connector to a helmet.

21. The body-worn supplied air respirator of claim 20, further comprising an inlet air pressure gauge.
